(19) United States
(12) Patent Application Publication
(10) Pub. No.: US 2004/0106714 A1
(43) Pub. Date: Jun. 3, 2004

(54) Polypropylene-based composition for fire resistant plastic material

(76) Inventor: Gerard Moraine, Velizy-Villacoublay (FR)

Correspondence Address: PARKHURST & WENDEL, L.L.P., 1421 PRINCE STREET, SUITE 210, ALEXANDRIA, VA, 22314-2805, US

(21) Appl. No.: 10/321,818

(22) Filed: Dec. 18, 2002

(30) Foreign Application Priority Data
Nov. 29, 2002 (FR) 02-15102

(51) Int. Cl. C08K 3/10; C08K 9/00

(52) U.S. Cl. 524/409; 523/200

(57) ABSTRACT

The invention relates to a polypropylene-based composition for a fire-resistant plastic material.

It comprises 80.5 to 93.5% in mass of polypropylene, 8 to 15% in mass of flame retardant, 0.5 to 4% of an additive encompassing an anti-ultraviolet component. The polypropylene is a copolymer constituted by blocks of polypropylene having a specific mass of around 900 kg/m³ and a Shore hardness of around 60. The flame retardant is an antimony trioxide and bromine-based composition and the additive is constituted by a polypropylene base encompassing an anti-ultraviolet component, a mixture of pigments and an admixture.

Application to the manufacture of extrusion blow-moulded parts.

### BACKGROUND OF THE INVENTION

The technical scope of the present invention is that of plastic materials intended for the manufacture of articles by extrusion blow-moulding.

The need for articles made of a plastic material having good fire resistance properties is becoming more and more pressing since the use of these plastics is becoming increasingly prevalent in numerous fields. One of these fields is that of furniture where plastic materials are abundantly used for ergonomic, design, cost reasons, etc.

Numerous documents describe plastic material-based compositions having good fire resistance properties. By way of example, patent JP-10017733 may be quoted, which describes a polypropylene polymer-based resin incorporating a mineral additive that is heat and fire resistant. But in most cases, it concerns specific polymers whose composition is well defined, but which are not able to be used for extrusion blow-moulding and whose sales price is very high. This type of product may not be applied in fields such as furnishing where the procurement cost of the material is high, adding to the price of the finished article.

The fire resistance properties of these components is an essential factor of choice because of problems linked to safety in the event of a fire. In the interior or exterior, collective or individual furniture market, reference is made to standards existing in the construction industry with respect to fire resistance. The so-called M classification corresponds to the reaction to fire, and flame propagation and the likelihood of generating burning drips is thereby characterised; the so-called F classification characterises the opacity of the fumes and the toxicity of the gases produced.

The need for a polymer composition able to be used in the furnishing field and having a fire resistant classification is a priority for industrialists in this sector.

The aim of the present invention is to supply a polypropylene-based composition suitable for the manufacture of parts by extrusion blow-moulding and intended, for example, for the furnishing industry.

### SUMMARY OF THE INVENTION

The invention thus relates to a polypropylene-based composition for a plastic material intended for the manufacture of fire resistant parts by extrusion blow-moulding, wherein it comprises:

80.5 to 90.5% in mass of polypropylene,

5 to 15% in mass of flame retardant,

0.5 to 4% of a first additive encompassing an anti-ultraviolet component and a colorant.

According to one characteristic of the invention, the polypropylene is a copolymer, having a specific mass of around 900 kg/m³ and a Shore hardness of around 60.

According to another characteristic of the invention, the flame retardant is an antimony trioxide and bromine-based composition.

According to yet another characteristic of the invention, the first additive is constituted by a polypropylene base encompassing an anti-ultraviolet component, a mixture of pigments and an admixture (aidprocessing).

According to another characteristic of the invention, the composition incorporates 81% in mass of polypropylene copolymer, 15% in mass of flame retardant and 4% in mass of additive.

According to another characteristic of the invention, the composition incorporates 84.5% in mass of polypropylene copolymer, 14% in mass of flame retardant, 1.5% in mass of additive.

According to another characteristic of the invention, the composition incorporates 87% in mass of polypropylene copolymer, 9.5% in mass of flame retardant and 3.5% in mass of additive.

According to another characteristic of the invention, the composition incorporates 89% in mass of polypropylene copolymer, 10% in mass of flame retardant and 1% in mass of additive.

According to another characteristic of the invention, the composition incorporates 92% in mass of polypropylene copolymer, 7% in mass of flame retardant and 1% in mass of additive.

According to another characteristic of the invention, the composition incorporates 93% in mass of polypropylene, 6% in mass of flame retardant and 1% in mass of additive.

The invention also relates to an extrusion blow-moulding process for a fire resistant plastic material which uses a composition such as that defined previously and a screw temperature profile of 180 to 190° C. with a peripheral spin speed of 0.2 m/s.

The invention also relates to a polypropylene-based composition for a fire-resistant plastic material, wherein it comprises:

80.5 to 93.5% in mass of polypropylene,

8 to 15% in mass of flame retardant,

0.5 to 4% of a first additive encompassing an anti-ultraviolet component and a pigments mixture, and

4 a 10% of a second additive enhancing fire resistance.

According a characteristic of the invention, the enhancing fire resistance additive is a silicon compounds.

According to another characteristic of the invention, the composition incorporates 82% in masse of polypropylene copolymer, 8% in mass of flame retardant MAXITHEN PP75, 2% in mass of the first additive MAXITHEN PP59107, and 8% in mass of the second additive Dow 4-7081.

According to another characteristic of the invention, the composition incorporates 88% in masse of polypropylene copolymer, 5% in mass of flame retardant EB42-80, 2% in mass of the first additive MAXITHEN PP59107, and 5% in mass of the second additive Dow 4-7081.

According to another characteristic of the invention, the composition incorporates 88% in masse of polypropylene copolymer, 5% in mass of flame retardant EB42-81, 2% in mass of the first additive MAXITHEN PP59107, and 5% in mass of the second additive Dow 4-7081.

According to another characteristic of the invention, the composition incorporates 88% in masse of polypropylene copolymer, 5% in mass of flame retardant MAXITHEN PP75, 2% in mass of the first additive MAXITHEN PP59107, and 5% in mass of the second additive Dow 4-7081.

According to another characteristic of the invention, the composition incorporates 85% in masse of polypropylene copolymer, 8% in mass of flame retardant MAXITHEN PP75, 2% in mass of the first additive MAXITHEN PP59107, and 5% in mass of the second additive Dow 4-7081.

According to another characteristic of the invention, the composition incorporates 85% in masse of polypropylene copolymer, 8% in mass of flame retardant MAXITHEN 75940 FR, 2% in mass of the first additive MAXITHEN PP62593, and 5% in mass of the second additive Dow 4-7081.

According to another characteristic of the invention, the composition incorporates 85% in masse of polypropylene copolymer, 8% in mass of flame retardant MAXITHEN 75940, 2% in mass of the first additive MAXITHEN PPSYS 75650, and 5% in mass of the second additive Dow 4-7081.

The first advantage of the present invention lies in that the parts made using the plastic material composition have excellent fire resistance properties.

Another advantage lies in the fact that the implementation of the compositions according to the invention does not require any particular adaptation of the extrusion blow-moulding process.

Another advantage lies in the fact that there is no significant drop in the mechanical strength and chemical behaviour of the parts made, nor is there any emission of odour or deterioration during recycling.

### DETAILED DESCRIPTION OF PREFERRED EMBODIMENTS

Other characteristics, particulars and advantages of the invention will become more apparent from the following description given by way of illustration.

As previously mentioned, commercially available polypropylene polymers could not be used to make parts by extrusion blow-moulding that have good fire resistance properties.

The invention makes important technical progress since for the first time it allows commercially available polypropylene polymers to be used to make parts by extrusion blow-moulding having excellent fire resistance properties. To prepare a composition made of a mixture of the components previously mentioned, able to be processed by extrusion blow-moulding, commercially available products are used.

Thus, the polypropylene copolymer may be the product sold by BOREALIS under the trade name BA202E. This polymer has a specific mass of 901 kg/m3, a modulus in flexure of 1300 Mpa and a Shore hardness of 60.

Generally speaking, the polypropylene copolymer used in the invention has a fluidity index of 0.3 g/10 mm at 230° C./2.16 kg according to the ISO standard 1133.

Several products may be used as flame retardant. It may be the product sold by GABRIEL-CHEMIE under the trade name MAXITHEN PP 75200 FR, or MAXITHEN PPSYS 75650 UVFR, MAXITHEN PP 75940 FR. This product is in the form of white granules and is an antimony trioxide and bromine-based composition. Other equivalent products sold by CIBA under the designation EB42-80 FF or EB42-81 FF may be used.

The first additive is constituted by one of the products sold by GABRIEL-CHEMIE under the trade name MAXITHEN PP91203UV, or MAXITHEN PP625937UV, or MAXITHEN PP59107/20UV, or MAXITHEN PPSYS529197. These additives are constituted by polypropylene enclosing an anti-ultraviolet component, a mixture of pigments as a classical colorant used in the plastics industries and an aidprocessing. The latter designates those products commonly used in the extrusion blow-moulding process to facilitate the operation. These products are sold under the form of pellets.

Surprisingly, it was discovered that by adopting the proportions indicated for the components, an extruded-blow-moulded article could be produced that has quite remarkable characteristics with respect to fire resistance. The results obtained are explained hereafter. The range of proportions of the components are thus required to obtain the promised result.

### EXAMPLE 1

A composition is prepared by mixing the powders according to the following percentages in a mixer for several hours:

81% in mass of polypropylene copolymer,

15% in mass of flame retardant, and

4% in mass of additive.

These components are closely mixed together to obtain a homogeneous product. This product is then implemented by extrusion blow-moulding according to the following process:

accumulation head extrusion blow-moulding press,

“thpm” profile screw without compression rate and with MADDOCK shearing modulus,

screw temperature profile θ of 180 to 190° C.,

peripheral spin speed limited to 0.2 m/s,

duration of cycle less than or equal to 3 mn.

The following compositions are prepared in the same way.

### EXAMPLE 2

84.5% in mass of polypropylene copolymer,

14% in mass of flame retardant, and

1.5% in mass of additive.

### EXAMPLE 3

87% in mass of polypropylene copolymer,

9.5% in mass of flame retardant, and

3.5% in mass of additive.

### EXAMPLE 4

89% in mass of polypropylene copolymer,

10% in mass of flame retardant, and

1% in mass of additive.

### EXAMPLE 5

92% in mass of polypropylene copolymer,

7% in mass of flame retardant, and

1% in mass of additive.

### EXAMPLE 6

93% in mass of polypropylene copolymer,

6% in mass of flame retardant, and

1% in mass of additive.

### EXAMPLE 7

A composition is prepared by mixing the powders according to the following percentages in a mixer for several hours:

82% in mass of polypropylene,

8% in mass of flame retardant MAXITHEN PP75,

2% in mass of the first additive MAXITHEN PP59107,

8% in mass of the second additive Dow 4-7081.

### EXAMPLE 8

88% in mass of polypropylene,

5% in mass of flame retardant EB42-80,

2% in mass of the first additive MAXITHEN PP59107,

5% in mass of the second additive Dow 4-7081.

### EXAMPLE 9

88% in mass of polypropylene,

5% in mass of flame retardant EB42-81,

2% in mass of the first additive MAXITHEN PP59107,

5% in mass of the second additive Dow 4-7081.

### EXAMPLE 10

88% in mass of polypropylene,

5% in mass of flame retardant MAXITHEN PP75,

2% in mass of the first additive MAXITHEN PP59107,

5% in mass of the second additive Dow 4-7081.

### EXAMPLE 11

85% in mass of polypropylene,

8% in mass of flame retardant MAXITHEN PP75,

2% in mass of the first additive MAXITHEN PP59107,

5% in mass of the second additive Dow 4-7081.

### EXAMPLE 12

85% in mass of polypropylene,

8% in mass of flame retardant MAXITHEN 75940 FR,

2% in mass of the first additive MAXITHEN PP62593,

5% in mass of the second additive Dow 4-7081.

### EXAMPLE 13

85% in mass of polypropylene,

8% in mass of flame retardant MAXITHEN 75940,

2% in mass of the first additive MAXITHEN PPSYS 75650,

5% in mass of the second additive Dow 4-7081.

In the indicated composition, the indicated compounds can be indiscriminally used.

Samples are prepared by extrusion blow-moulding using the above composition to determine their fire resistance according to French Standard NFP 92-505 and their smoke index according to French Standard NF X 70-100 and STM-S-001.

To test their fire resistance, the samples prepared are subjected to the action of a radiating heat source and the ignition of the gases given off and the propagated of the gases emitted may be occasioned. We note that the exposed face ignites after a duration of between 1 mn 43 and 2 mn 15. The maximum flame length is of between 25 and 30 cm.

The following additional test, the drip test, is then carried out using an epiradiator in the horizontal position 30 mm above the plate, radiating surface downwards. The inflammation of the released gases and the fall of burning drips can be observed. The molten material falls after a lapse of time of around 1 mn 45 s to 3 mn 2 s. The material is on fire and the residue is constituted by molten material.

The results of the fire reaction test give the product according to the invention an M2 classification, according to the standard for pyrolysis and combustion gas analysis and to the French standard NF X 10-702 & STM-S-001.

In the smoke index determination test, the following results were obtained:

| | |
|---|---|
| C.T.I.: | 13.7 |
| Dm: | 334 |
| VOF4: | 376 |
| Smoke index: | 23 |

These results give the extrusion blow-moulded products prepared according to the invention an F2 classification, which represents a very high performance level.

Pyrolysis and combustion analyses were carried out.

The following results were obtained:

| | |
|---|---|
| Carbon monoxide CO: | 99.2 mg, |
| Carbon Dioxide CO2: | 446.6 mg, |
| Hydrocyanic acid: | not detected, |
| Halogenated acids HCl and HF: | not detected |
| Halogenated acid HBr: | 12.8 mg, |
| Sulphur dioxide: | not detected |

The conventional toxicity index (CTI) is of 13.7.

The specific optical density of the smoke emitted by the combustion or pyrolysis of the solid material is measured. For this, tests are carried out in flameless mode (trial 1) and flame mode (trials 2-4). We measured the time in seconds to attain maximal optical density (Dm), the maximal specific optical density (Dsm) and the obscuration value due to the make after the first four minutes of the trial and obtained the following results:

| | Trial | Trial | Trial | Trial |
|---|---|---|---|---|
| Characteristics | 1 | 2 | 3 | 4 |
| Dm | 1193 | 498 | 363 | 431 |
| Dsm | 251 | 395 | 294 | 314 |
| VOF4 | 54 | 378 | 392 | 359 |

An average Dsm of 334 s and an average VOF4 of 376 is obtained.

Thus, the composition of the plastic material according to the invention allows extruded parts to be made that have excellent fire resistance properties, giving them an official M2F2 classification, whilst using commercially available components.

What is claimed is:

1. A polypropylene-based composition for fire-resistant plastic material, wherein it comprises:
80.5 to 93.5% in mass of polypropylene,
8 to 15% in mass of flame retardant,
0.5 to 4% of an additive encompassing an anti-ultraviolet component and a colorant.

2. A composition for a plastic material according to claim 1, wherein the polypropylene is a copolymer constituted by blocks of polypropylene having a specific mass of around 900 kg/m³ and a Shore hardness of around 60.

3. A composition for a plastic material according to claims 1 or 2, wherein the flame retardant is an antimony trioxide and bromine-based composition.

4. A composition for a plastic material according to claim 3, wherein the additive is constituted by a polypropylene base encompassing an anti-ultraviolet component, a mixture of pigments and an admixture.

5. A composition for a plastic material according to one of the above claims, wherein it incorporates 81% in mass of polypropylene copolymer, 15% in mass of flame retardant and 4% in mass of additive.

6. A composition for a plastic material according to any one of claims 1 to 4, wherein it incorporates 84.5% in mass of polypropylene copolymer, 14% in mass of flame retardant and 1.5% in mass of additive.

7. A composition for a plastic material according to any one of claims 1 to 4, wherein it incorporates 87% in mass of polypropylene copolymer, 9.5% in mass of flame retardant and 3.5% in mass of additive.

8. A composition for a plastic material according to any one of claims 1 to 4, wherein it incorporates 89% in mass of polypropylene copolymer, 10% in mass of flame retardant and 1% in mass of additive.

9. A composition for a plastic material according to any one of claims 1 to 4, wherein it incorporates 92% in mass of polypropylene copolymer, 7% in mass of flame retardant and 1% in mass of additive.

10. A composition for a plastic material according to any one of claims 1 to 4, wherein it incorporates 93% in mass of polypropylene, 6% in mass of flame retardant and 1% in mass of additive.

11. An extrusion blow-moulding process for a fire resistant plastic material, wherein a composition such as that defined previously is used and wherein a screw temperature profile of 180 to 190° C. with a peripheral spin speed of 0.2 m/s is adopted.

12. A polypropylene-based composition for a fire-resistant plastic material, wherein it comprises:
80.5 to 93.5% in mass of polypropylene,
8 to 15% in mass of flame retardant,
0.5 to 4% of a first additive encompassing an anti-ultraviolet component and a colorant, and
4 a 10% of a second additive based on silicon compounds enhancing fire resistance.

13. A polypropylene-based composition for a fire-resistant plastic material according to claim 12, wherein it comprises:
82% in mass of polypropylene,
8% in mass of flame retardant MAXITHEN PP75,
2% in mass of the first additive MAXITHEN PP59107,
8% in mass of the second additive Dow 4-7081.

14. A polypropylene-based composition for a fire-resistant plastic material according to claim 12, wherein it comprises:
88% in mass of polypropylene,
5% in mass of flame retardant EB42-80,
2% in mass of the first additive MAXITHEN PP59107,
5% in mass of the second additive Dow 4-7081.

15. A polypropylene-based composition for a fire-resistant plastic material according to claim 12, wherein it comprises:
88% in mass of polypropylene,
5% in mass of flame retardant EB42-81,
2% in mass of the first additive MAXITHEN PP59107,
5% in mass of the second additive Dow 4-7081.

16. A polypropylene-based composition for a fire-resistant plastic material according to claim 12, wherein it comprises:
88% in mass of polypropylene,
5% in mass of flame retardant MAXITHEN PP75,
2% in mass of the first additive MAXITHEN PP59107,
5% in mass of the second additive Dow 4-7081.

17. A polypropylene-based composition for a fire-resistant plastic material according to claim 12, wherein it comprises:
85% in mass of polypropylene,
8% in mass of flame retardant MAXITHEN PP75,
2% in mass of the first additive MAXITHEN PP59107,
5% in mass of the second additive Dow 4-7081.

18. A polypropylene-based composition for a fire-resistant plastic material according to claim 12, wherein it comprises:
85% in mass of polypropylene,
8% in mass of flame retardant MAXITHEN 75940 FR,
2% in mass of the first additive MAXITHEN PP62593,
5% in mass of the second additive Dow 4-7081.

19. A polypropylene-based composition for a fire-resistant plastic material according to claim 12, wherein it comprises:
85% in mass of polypropylene,
8% in mass of flame retardant MAXITHEN 75940,
2% in mass of the first additive MAXITHEN PPSYS 75650,
5% in mass of the second additive Dow 4-7081.
